(19) United States
(12) Patent Application Publication
(10) Pub. No.: US 2022/0286600 A1
(43) Pub. Date: Sep. 8, 2022

(54) IMAGE-CAPTURING ASSISTANCE DEVICE AND IMAGE-CAPTURING ASSISTANCE METHOD

(71) Applicant: HONDA MOTOR CO., LTD., Tokyo (JP)

(72) Inventors: Haisong Liu, Tokyo (JP); Ryo Morosawa, Tokyo (JP)

(21) Appl. No.: 17/674,972

(22) Filed: Feb. 18, 2022

(30) Foreign Application Priority Data
Mar. 5, 2021 (JP) 2021-035626

(51) Int. Cl. H04N 5/232; H04N 5/247

(52) U.S. Cl. CPC H04N 5/23219; H04N 5/247; H04N 5/23206

(57) ABSTRACT

An image-capturing assistance device includes: a lighting unit that is mounted on a vehicle and emits light toward the outside of the vehicle; a target-person recognition unit that recognizes a target person present around the vehicle; a distance-degree recognition unit that recognizes a distance degree of the target person relative to a specified position set within an image-capturing range of a camera; and a lighting control unit that controls a lighting mode of the lighting unit based on the distance degree.

### INCORPORATION BY REFERENCE

The present application claims priority under 35 U.S.C. § 119 to Japanese Patent Application No. 2021-035626 filed on Mar. 5, 2021. The content of the application is incorporated herein by reference in its entirety.

### BACKGROUND OF THE INVENTION

### Field of the Invention

The present invention relates to an image-capturing assistance device and an image-capturing assistance method.

### Description of the Related Art

There has been proposed a keyless entry system in which an in-vehicle camera captures images of surroundings of a vehicle to perform user authentication by using information on the irises of a target person approaching the vehicle that is extracted from an image including the target person for controlling entry to the vehicle (for example, refer to Japanese Patent Laid-Open No. 2003-138817).

In the case in which an image of the face of a target person is captured by an in-vehicle camera as in the keyless entry system described above, it is desired to capture an image of the target person in a state in which the target person is positioned at an appropriate place within the image-capturing range of the in-vehicle camera.

The present invention has been made in light of the above background, and an object thereof is to provide an image-capturing assistance device and an image-capturing assistance method that make it possible to guide a target person positioned around a vehicle to a position suitable for image-capturing by a camera mounted on the vehicle.

### SUMMARY OF THE INVENTION

A first aspect to achieve the above object is an image-capturing assistance device for assisting a camera mounted on a vehicle in capturing an image of surroundings of the vehicle, the image-capturing assistance device including: a lighting unit that is mounted on the vehicle and emits light toward the outside of the vehicle; a target-person recognition unit that recognizes a target person present around the vehicle; a distance-degree recognition unit that recognizes a distance degree of the target person relative to a specified position set within an image-capturing range of the camera; and a lighting control unit that controls a lighting mode of the lighting unit based on the distance degree.

The above image-capturing assistance device may have a configuration in which the lighting control unit, when recognizing based on change in the distance degree that the target person is coming closer to the specified position, makes the lighting unit blinking, when recognizing based on change in the distance degree that the target person is going away from the specified position, turns off the lighting unit, and when the distance degree is lower than or equal to a first determination level, turns on the lighting unit.

The above image-capturing assistance device may have a configuration in which the lighting unit has a function of displaying an arrow, and the lighting control unit, when the distance degree is higher than or equal to a second determination level, displays the arrow by using the lighting unit such that the arrow points a direction corresponding to a direction to decrease the distance degree.

The above image-capturing assistance device may have a configuration in which the lighting unit includes a lighting element and a sliding unit that slides the lighting element in a width direction of the vehicle, and the lighting control unit slides and positions the lighting element by using the sliding unit such that the lower the distance degree, the longer the distance of the lighting element from an end portion of the sliding unit on a vehicle outer side of the vehicle.

The above image-capturing assistance device may have a configuration in which the image-capturing assistance device further includes a camera control unit that activates the camera when the distance degree is lower than or equal to a third determination level.

The above image-capturing assistance device may have a configuration in which the image-capturing assistance device further includes a target-person-speed recognition unit that recognizes a moving speed of the target person, and when the moving speed of the target person recognized by the target-person-speed recognition unit is higher than or equal to a specified speed, the camera control unit does not activate the camera even if the distance degree is lower than or equal to the third determination level.

A second aspect to achieve the above object is an image-capturing assistance method executed by a computer, for assisting a camera mounted on a vehicle in capturing an image of surroundings of the vehicle, the image-capturing assistance method including: a target-person recognition step of recognizing a target person present around the vehicle; a distance-degree recognition step of recognizing a distance degree of the target person relative to a specified position set within an image-capturing range of the camera; and a lighting control step of controlling, based on the distance degree, a lighting mode of a lighting unit that is mounted on the vehicle and emits light toward the outside of the vehicle.

### Advantageous Effect of Invention

With the above image-capturing assistance device, it is possible to guide a target person positioned around the vehicle to a position suitable for image-capturing by a camera mounted on the vehicle.

### BRIEF DESCRIPTION OF THE DRAWINGS

FIG. 1 is a configuration diagram of a vehicle on which an image-capturing assistance device is mounted;

FIG. 2 is a configuration diagram of the image-capturing assistance device;

FIG. 3 is an explanatory diagram of a configuration in which the lighting mode of a lighting unit is changed according to how a target person is approaching a specified position;

FIG. 4 is a table for explaining the on-off condition of the lighting unit;

FIG. 5 is a flowchart of an image-capturing assistance process;

FIG. 6 is an explanatory diagram of a configuration in which a left arrow or a right arrow is displayed depending on from which direction a target person is approaching the specified position;

FIG. 7 is an explanatory diagram of a configuration in which an LED is slid in a width direction of the vehicle according to how a target person is approaching the specified position; and

FIG. 8 is a flowchart of another embodiment of the image-capturing assistance process.

### DETAILED DESCRIPTION OF THE PREFERRED EMBODIMENTS

[1. Configuration of Vehicle]

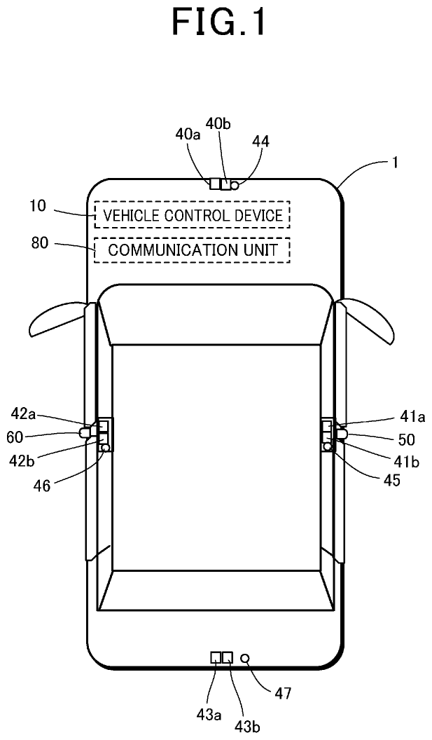

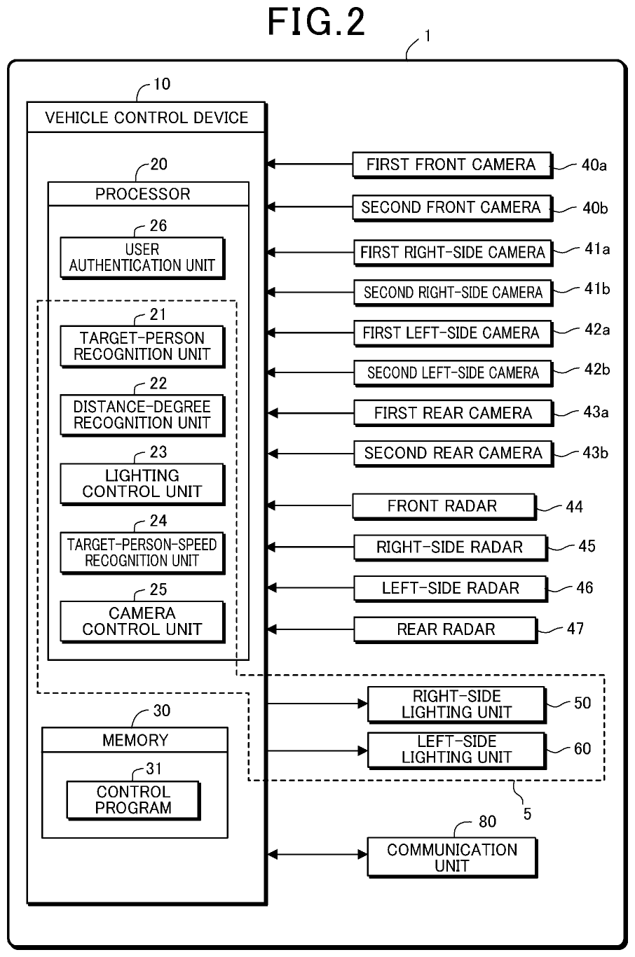

With reference to FIG. 1, the configuration of a vehicle 1 on which an image-capturing assistance device 5 (see FIG. 2) of the present embodiment is mounted will be described. The image-capturing assistance device 5, although details will be described later, includes part of the functions of a vehicle control device 10, a right-side lighting unit 50, and a left-side lighting unit 60.

The vehicle 1 includes, at its front, first and second front cameras 40a and 40b which capture images of the forward view of the vehicle 1 and a front radar 44 which detects the position of a target object present in front of the vehicle 1. The second front camera 40b has a higher resolution than the first front camera 40a. The second front camera 40b consumes more electric power than the first front camera 40a.

The vehicle 1 includes, at its back, first and second rear cameras 43a and 43b which capture images of the rearward view of the vehicle 1 and a rear radar 47 which detects the position of a target object present behind the vehicle 1. The second rear camera 43b has a higher resolution than the first rear camera 43a. The second rear camera 43b consumes more electric power than the first rear camera 43a.

The vehicle 1 includes, on its right side, first and second right-side cameras 41a and 41b which capture images on the right side of the vehicle 1, a right-side radar 45 which detects the position of a target object present on the right side of the vehicle 1, and the right-side lighting unit 50 which emits light toward the outside of the vehicle 1. The second right-side camera 41b has a higher resolution than the first right-side camera 41a. The second right-side camera 41b consumes more electric power than the first right-side camera 41a.

The vehicle 1 includes, on its left side, first and second left-side cameras 42a and 42b which capture images on the left side of the vehicle 1, a left-side radar 46 which detects the position of the target object present on the left side of the vehicle 1, and the left-side lighting unit 60 which emits light toward the outside of the vehicle 1. The second left-side camera 42b has a higher resolution than the first left-side camera 42a. The second left-side camera 42b consumes more electric power than the first left-side camera 42a.

The vehicle 1 further includes a communication unit 80. The communication unit 80 communicates with mobile terminals used by pedestrians positioned around the vehicle 1, other vehicles, external servers, roadside devices, and the like.

[2. Configuration of Image-Capturing Assistance Device]

With reference to FIG. 2, the configuration of the image-capturing assistance device 5 will be described. The image-capturing assistance device 5 includes part of the functions of the vehicle control device 10, the right-side lighting unit 50, and the left-side lighting unit 60. The vehicle control device 10 is a control unit including a processor 20, memory 30, a not-illustrated interface circuit, and the like.

The processor 20 reads and executes a control program 31 stored in the memory 30 to function as a target-person recognition unit 21, a distance-degree recognition unit 22, a lighting control unit 23, a target-person-speed recognition unit 24, a camera control unit 25, and a user authentication unit 26. The target-person recognition unit 21, the distance-degree recognition unit 22, the lighting control unit 23, the target-person-speed recognition unit 24, the camera control unit 25, the right-side lighting unit 50, and the left-side lighting unit 60 compose the image-capturing assistance device 5. The functions of the target-person recognition unit 21, the distance-degree recognition unit 22, the lighting control unit 23, the target-person-speed recognition unit 24, and the camera control unit 25 will be described later.

Processes executed by the target-person recognition unit 21 correspond to a target-person recognition step in an image-capturing assistance method of the present disclosure, and processes executed by the distance-degree recognition unit 22 correspond to a distance-degree recognition step in the image-capturing assistance method of the present disclosure. Processes executed by the lighting control unit 23 correspond to a lighting control step in the image-capturing assistance method of the present disclosure, and processes executed by the target-person-speed recognition unit 24 correspond to a target-person-speed recognition step in the image-capturing assistance method of the present disclosure. Processes executed by the camera control unit 25 correspond to a camera control step in the image-capturing assistance method of the present disclosure.

The vehicle control device 10 receives input of images captured by the first front camera 40a, the second front camera 40b, the first right-side camera 41a, the second right-side camera 41b, the first left-side camera 42a, the second left-side camera 42b, the first rear camera 43a, and the second rear camera 43b and data on the positions of target objects detected by the front radar 44, the right-side radar 45, the left-side radar 46, and the rear radar 47.

The lighting modes of the right-side lighting unit 50 and the left-side lighting unit 60 are controlled by control signals outputted from the vehicle control device 10. The vehicle control device 10 communicates with other vehicles or the like via the communication unit 80.

The target-person recognition unit 21 recognizes target persons present around the vehicle 1 based on images captured by the first front camera 40a, the second front camera 40b, the first right-side camera 41a, the second right-side camera 41b, the first left-side camera 42a, the second left-side camera 42b, the first rear camera 43a, and the second rear camera 43b and data on the positions of target objects detected by the front radar 44, the right-side radar 45, the left-side radar 46, and the rear radar 47. The target persons include the user of the vehicle 1 and passersby other than the user.

The target-person recognition unit 21, in the case in which high-resolution image capturing is not necessary, uses the first front camera 40a, the first right-side camera 41a, the first left-side camera 42a, and the first rear camera 43a, which consume less electric power, to capture images of the surroundings of the vehicle 1. However, in the case in which high-resolution image capturing is necessary, the target-person recognition unit 21 uses the second front camera 40b, the second right-side camera 41b, the second left-side camera 42b, and the second rear camera 43b to capture images of the surroundings of the vehicle 1.

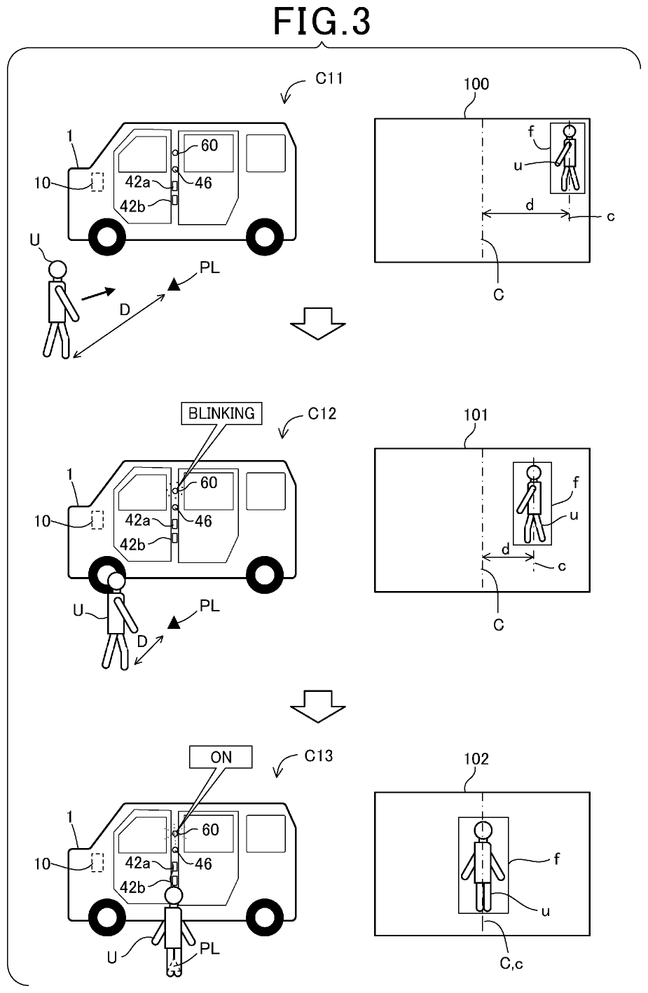

The distance-degree recognition unit 22, as illustrated in FIG. 3, recognizes a distance degree D between a specified position PL set within the range of the second left-side camera 42b and a target person U recognized by the target-person recognition unit 21. FIG. 3 illustrates situations C11→C12→C13 in which the target person U is gradually coming closer to the specified position PL. In FIG. 3, the distance degree D is shown, as an example, as the distance between the specified position PL and the target person U. Note that in the case in which the target person U is positioned on the right side of the vehicle 1, the distance-degree recognition unit 22 recognizes the distance degree D between the target person U and a specified position PR set in the same or similar way within the image-capturing range of the second right-side camera 41b.

The following describes an image-capturing assistance process of changing the lighting mode of the left-side lighting unit 60, executed by the image-capturing assistance device 5 in the case in which the target person U approaches the specified position PL from the left side of the vehicle 1 as illustrated in FIG. 3. In the case in which the target person U comes closer to the vehicle 1 from the right side of the vehicle 1, the image-capturing assistance device 5 executes the same or a similar image-capturing assistance process on the right-side lighting unit 50. The specified position PL is set at the position that corresponds, in the length direction (front-rear direction) of the vehicle 1, the position of the center line in the horizontal direction of an image 100 captured by the second left-side camera 42b and that corresponds, in the width direction (right-left direction) of the vehicle 1, the focal distance of the second left-side camera 42b.

The distance-degree recognition unit 22 recognizes the distance degree D of the target person U relative to the specified position PL in the length direction of the vehicle 1 based on a distance d between a center line C in the horizontal coordinate direction of the image 100 and images 101 and 102 captured by the second left-side camera 42b and a center line c in the horizontal coordinate direction of a determination frame f of an image part u of the target person U. In the length direction of the vehicle 1, the farther the target person U is positioned from the specified position PL, the longer the distance d is.

The distance-degree recognition unit 22, in the width direction of the vehicle 1, recognizes the distance degree D of the target person U relative to the specified position PL based on the size of the determination frame f of the image part u of the target person U in the images 100, 101, and 102 captured by the second left-side camera 42b. In the width direction of the vehicle 1, the closer to the specified position PL the target person U comes, the larger the determination frame f becomes.

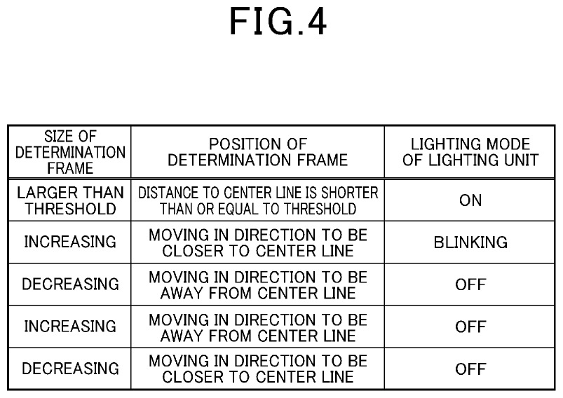

Based on the distance degree D of the target person U relative to the specified position PL, recognized by the distance-degree recognition unit 22, the lighting control unit 23 controls the lighting mode of the left-side lighting unit 60 according to the lighting condition table illustrated in FIG. 4. Specifically, the lighting control unit 23 controls the lighting mode of the left-side lighting unit 60 according to the following conditions (1) to (3) as illustrated in FIG. 4.

(1) The blinking-condition of the left-side lighting unit 60: The size of the determination frame f is increasing (in the width direction of the vehicle 1, the target person U is approaching the specified position PL), and the center line c of the determination frame f is moving in the direction to be closer to the center line C of the captured image (in the length direction of the vehicle 1, the target person U is approaching the specified position PL). In this case, the lighting control unit 23 makes the left-side lighting unit 60 blinking (the state from C11 to C12 in FIG. 3). This blinking makes it possible to notify the target person U that the target person U is proceeding toward the position optimum for image-capturing by the second left-side camera 42b and prompt the target person U to proceed in the same direction to the specified position PL.

(2) The on-condition of the left-side lighting unit 60: The size of the determination frame f has exceeded a threshold (in the width direction of the vehicle 1, the target person U has reached the vicinity of the specified position PL), and the distance d between the center line c of the determination frame f and the center line C of the captured image has become shorter than or equal to a threshold (in the length direction of the vehicle 1, the target person U is positioned in the vicinity of the specified position PL). The level of the distance degree D in this case corresponds to a first determination level or a third determination level. In this case, the lighting control unit 23 turns on the left-side lighting unit 60. This turning-on makes it possible to notify the target person U that the target person U is standing at the position optimum for image-capturing by the second left-side camera 42b. Then, the second left-side camera 42b can capture an image of the target person U appropriately.

(3) The off-condition of the left-side lighting unit 60: The size of the determination frame f is decreasing (in the width direction of the vehicle 1, the target person U is proceeding in a direction to be away from the specified position PL), or the center line c of the determination frame f is moving in a direction to be away from the center line C of the captured image (in the length direction of the vehicle 1, the target person U is proceeding in a direction to be away from the specified position PL). In this case, the lighting control unit 23 turns off the left-side lighting unit 60. This turning-off makes it possible to notify the target person U that the target person U is proceeding in a direction to be away from the position optimum for image-capturing by the second left-side camera 42b and prompt the target person U to change the moving direction to proceed toward the specified position PL.

The target-person-speed recognition unit 24 recognizes the moving speed of the target person U based on change in the distance degree D of the target person U relative to the specified position PL, recognized by the distance-degree recognition unit 22. Note that the target-person-speed recognition unit 24 may recognize the moving speed of the target person U based on change in the position of the target person U detected by the left-side radar 46. Alternatively, the target-person-speed recognition unit 24 may recognize the moving speed of the target person U based on change in the position of the determination frame f in the image captured by the first left-side camera 42a.

When the distance degree D of the target person U relative to the specified position PL, recognized by the distance-degree recognition unit 22 is lower than or equal to the first determination level shown in the above (2), and the speed of the target person U recognized by the target-person-speed recognition unit 24 is lower than a specified speed, the camera control unit 25 activates the second left-side camera 42b and captures an image of the target person U by using the second left-side camera 42b. Determining the moving speed of the target person U as described above makes it possible to save electric power consumption of the second left-side camera 42b by not activating the second left-side camera 42b for target persons U who are not the user of the vehicle 1 but just passing by near the vehicle 1. Note that the activation condition of the second left-side camera 42b may be set to a second determination level different from the first determination level. For example, the second determination level may be set smaller than the first determination level to activate the second left-side camera 42b at the time when the target person U is much closer to the specified position PL.

The user authentication unit 26 performs an authentication process on a face image of the target person U captured by the second left-side camera 42b, by using a face image of the user of the vehicle 1 stored in the memory 30. In the case in which the target person U is authenticated as the user of the vehicle 1, the user authentication unit 26 performs a process of unlocking the vehicle 1 or the like to permit the target person U to enter the vehicle 1.

[3. Image-Capturing Assistance Process]

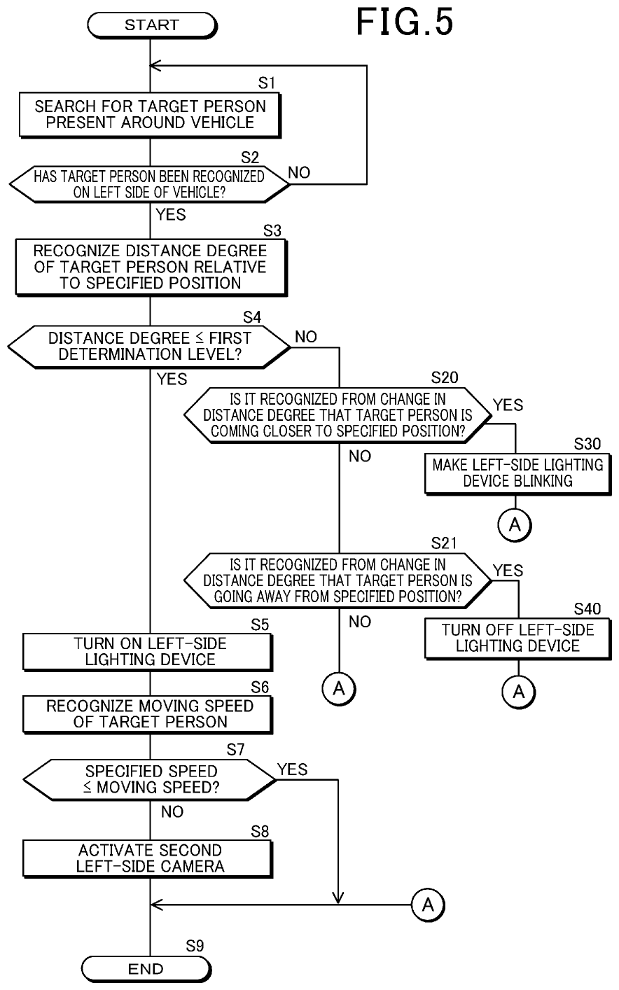

Following a flowchart illustrated in FIG. 5, a description will be given of an image-capturing assistance process executed by the image-capturing assistance device 5 in the foregoing situation in FIG. 3. In step S1, the target-person recognition unit 21 extracts an image part of a target person from images captured by the first right-side camera 41a and the first left-side camera 42a to search for a target person present around the vehicle 1. In the succeeding step S2, if the target-person recognition unit 21 recognizes a target person U on the left side of the vehicle 1, the process proceeds to step S3, or if not, the process proceeds to step S1. In the example of FIG. 3, a target person U present on the left side of the vehicle 1 is recognized from the image 100 captured by the first left-side camera 42a.

In step S3, the distance-degree recognition unit 22 recognizes the distance degree D of the target person U relative to the specified position PL based on the size of the determination frame f of the image part u of the target person U in the images 100 to 102 captured by the first left-side camera 42a and the distance d between the center line c of the determination frame f and the center line C of the captured images.

In step S4, the lighting control unit 23 determines whether the distance degree D between the target person U and the specified position PL is lower than or equal to a first specified level which is the on-condition of the above (2). Then, if the distance degree D between the target person U and the specified position PL is lower than or equal to the first specified level, the lighting control unit 23 advances the process to step S5, and if the distance degree D between the target person U and the specified position PL is higher than the first specified level, it advances the process to step S20.

In step S20, the lighting control unit 23 determines whether the target person U is moving in a direction to be closer to the specified position PL, which is the blinking-condition of the above (1), from change in the distance degree D recognized by the distance-degree recognition unit 22. Then, if the lighting control unit 23 recognizes that the target person U is moving in a direction to be closer to the specified position PL, the lighting control unit 23 advances the process to step S30, and if the lighting control unit 23 recognizes that the target person U is not moving in a direction to be closer to the specified position PL, it advances the process to step S21. In step S30, the lighting control unit 23 makes the left-side lighting unit 60 blinking and advances the process to step S9.

In step S21, the lighting control unit 23 determines whether the target person U is moving in a direction to be away from the specified position PL, which is the off-condition of the above (3), from change in the distance degree D recognized by the distance-degree recognition unit 22. Then, if the lighting control unit 23 recognizes that the target person U is moving in a direction to be away from the specified position PL, it advances the process to step S40, and if the lighting control unit 23 determines that the target person U is not moving in a direction to be away from the specified position PL, it advances the process to step S9. In step S40, the lighting control unit 23 turn off the left-side lighting unit 60 and advances the process to step S9.

In step S5, the lighting control unit 23 turns on the left-side lighting unit 60 (in the state of C13 in FIG. 3). In the succeeding step S6, the target-person-speed recognition unit 24 recognizes the moving speed of the target person U. In the next step S7, the camera control unit 25 determines whether the moving speed of the target person U is higher than or equal to a specified speed. If the moving speed of the target person U is higher than or equal to the specified speed, the camera control unit 25 advances the process to step S9, and if the moving speed of the target person U is lower than the specified speed, the camera control unit 25 advances the process to step S8.

In step S8, the camera control unit 25 activates the second left-side camera 42b and captures an image of the target person U with the second left-side camera 42b. With the image-capturing assistance process according to the flowchart of FIG. 5, it is possible to guide the target person U coming closer to the door of the vehicle 1 from the left side of the vehicle 1, toward the specified position PL by using the lighting mode of the left-side lighting unit 60 and to capture an image of the target person U appropriately with the second left-side camera 42b.

Although the above description is about an example of executing a process to capture an image of the target person U appropriately by using the first left-side camera 42a and the second left-side camera 42b provided on the vehicle 1 at the positions illustrated in FIG. 3, application of the present invention makes it possible for cameras attached to any positions on the vehicle 1 to guide a target person U and capture an image of the target person U appropriately.

[4. Other Embodiments]

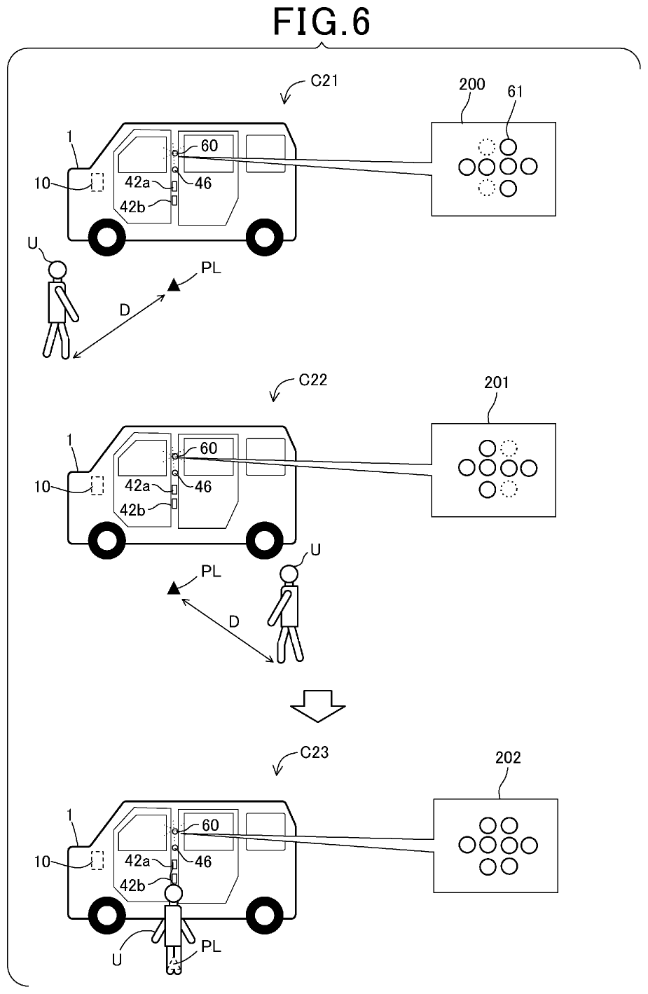

FIG. 6 illustrates a configuration of a left-side lighting unit 60 that includes 7 LEDs 61 (which correspond to light emission devices in the present disclosure) and displays a right arrow 200 pointing the right direction and a left arrow 201 pointing the left direction, seen from the target person U. In this configuration, in the case in which the target person U is positioned on the left side of the specified position PL, and the distance degree D is higher than or equal to the second determination level, as illustrated in C21, the lighting control unit 23 displays the right arrow 200 pointing the direction to decrease the distance degree D between the target person U and the specified position PL by using the left-side lighting unit 60.

In the case in which the target person U is positioned on the right side of the vehicle 1, and the distance degree D is higher than or equal to the second determination level, as illustrated in C22, the lighting control unit 23 displays the left arrow 201 pointing the direction to decrease the distance degree D between the target person U and the specified position PL by using the left-side lighting unit 60. When the distance degree D between the target person U and the specified position PL decreases to be lower than or equal to the first determination level as illustrated in C23, the lighting control unit 23 turns on all the LEDs of the left-side lighting unit 60.

In this way, the right arrow 200 or the left arrow 201 is turned on to match the direction to decrease the distance degree D between the target person U and the specified position PL, so that it is possible to guide the target person U to the specified position PL. The right-side lighting unit 50 has the same or a similar configuration, and the lighting control unit 23 performs a process to display a right arrow or a left arrow to the target person U positioned on the right side of the vehicle 1.

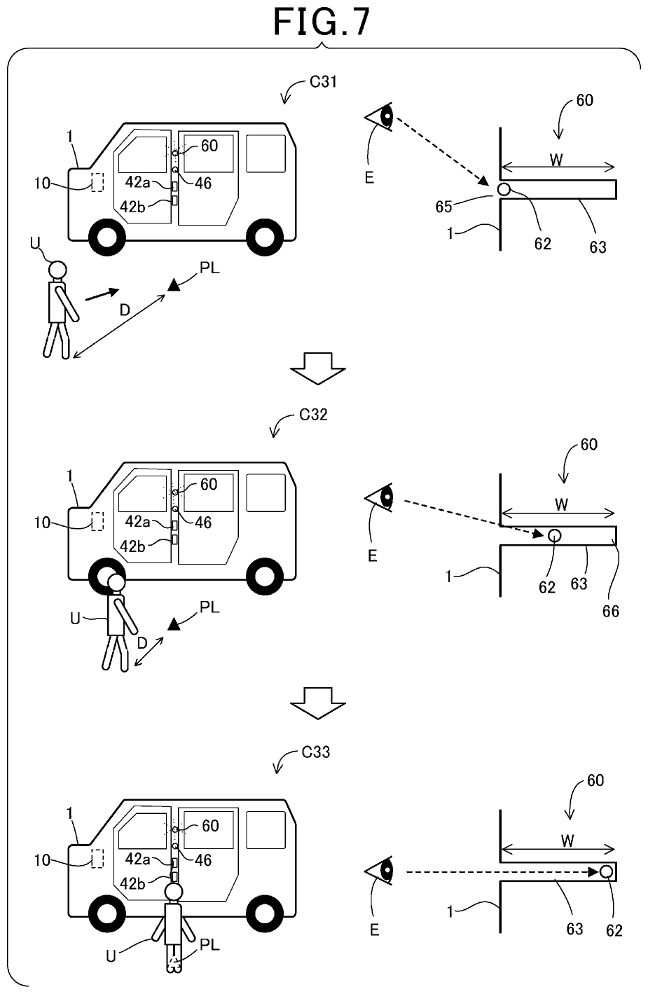

Next, FIG. 7 illustrates an embodiment in which a left-side lighting unit 60 includes a light emission device 62 and a sliding unit 63 that slides the light emission device 62 in a width direction W (right-left direction) of the vehicle 1. The left-side lighting unit 60 is disposed such that its position in the length direction of the vehicle 1 is the same as the position of the second left-side camera 42b. As illustrated in C31, when the distance degree D between the target person U and the specified position PL is high, the lighting control unit 23 positions the light emission device 62 near an end portion 65 on the outer side of the vehicle 1 (the side closer to the target person U) so that the light emission device 62 is easier to be seen by eyes E of the target person U.

As illustrated in C32, in the case in which the target person U comes closer to the vehicle 1, and the distance degree D between the target person U and the specified position PL decreases, the lighting control unit 23 makes the sliding unit 63 slide the light emission device 62 toward an end portion 66 on the vehicle inner side of the vehicle 1 (the side away from the target person U). This makes a state in which unless the target person U comes closer to the specified position PL, the light emission device 62 is difficult to be seen by the eyes E of the target person U, and this makes it possible to guide the target person U to the specified position PL.

Then, as illustrated in C33, when the distance degree D between the target person U and the specified position PL becomes lower than or equal to the first determination level, and the target person U faces the second left-side camera 42b, the lighting control unit 23 slides the light emission device 62 to near the end portion on the vehicle inner side of the vehicle 1. This makes a state in which the light emission device 62 is easiest to be seen from the target person U when the target person U is positioned right in front of the second left-side camera 42b, and this makes it possible to guide the target person U to the optimum image-capturing position for the second left-side camera 42b.

The right-side lighting unit 50 has a configuration the same as or a similar to that of the left-side lighting unit 60, and the lighting control unit 23 executes a process of sliding the light emission device of the right-side lighting unit 50 according to the distance degree D between the target person U and the right specified position PR.

Although the embodiment described above includes the target-person-speed recognition unit 24, and when the moving speed of the target person U is higher than or equal to a specified speed, the processes in steps S6 and S7 in FIG. 5 prohibit activation of the second left-side camera 42b, a configuration without the target-person-speed recognition unit 24 is also possible. In the case in which the target-person-speed recognition unit 24 is omitted, the process transitions from step S5 to step S8. Although the above embodiment includes the first front camera 40a and the second front camera 40b, those cameras may be an integrated camera or may be separate cameras. Also in the case in which they are an integrated camera, the relationship in which the second front camera 40b has a higher resolution than the first front camera 40a and the relationship in which the second front camera 40b consumes more electric power than the first front camera 40a are unchanged. In other words, the first front camera 40a captures images in a low-resolution small-current image-capturing mode, and the second front camera 40b captures images in a high-resolution large-current image-capturing mode.

The same applies to the relationship between the first rear camera 43a and the second rear camera 43b, the relationship between the first right-side camera 41a and the second right-side camera 41b, and the relationship between the first left-side camera 42a and the second left-side camera 42b.

Although the above embodiment describes, as an example, a case in which the target person U gets in the vehicle 1, the lighting units may be provided at a front portion of the vehicle 1 or a rear portion of the vehicle 1, and control the same as or similar to that in FIGS. 3 and 5 may be executed. In that case, in step S1 in FIG. 5, a process of searching for a target person U present around the vehicle 1 is executed by extracting an image part of the target person U from images captured by the first front camera 40a or the first rear camera 43a. When a target person U is recognized from an image captured by the first front camera 40a, the second front camera 40b may capture an image of the target person U, and if the target person U is authenticated as the user of the vehicle 1, the hood may be unlocked and opened. When a target person U is recognized from an image captured by the first rear camera 43a, the second rear camera 43b may capture an image of the target person U, and if the target person U is authenticated as the user of the vehicle 1, the tailgate (trunk) may be unlocked and opened.

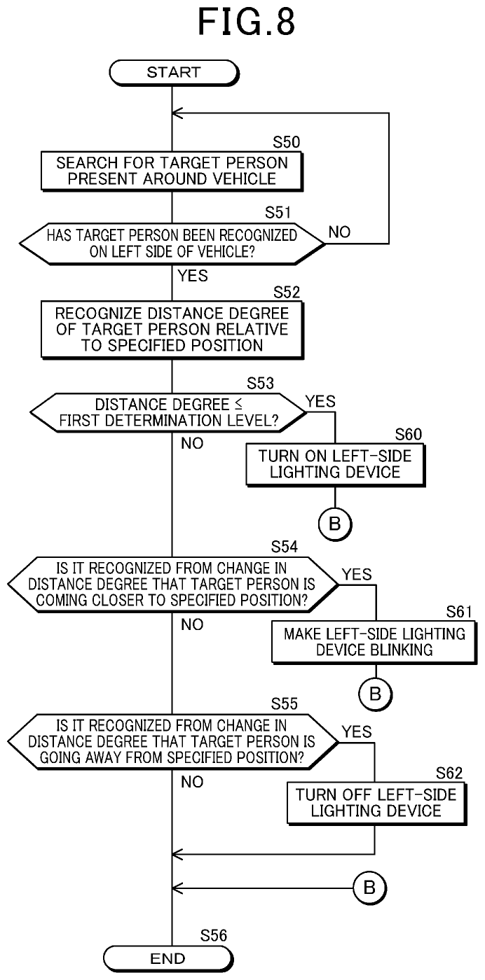

Although in the above embodiment, when the distance degree D becomes lower than or equal to the first determination level in step S4, the second left-side camera 42b is activated in step S8 according to the flowchart illustrated in FIG. 5, the process in the flowchart illustrated in FIG. 8 may be executed instead. The flowchart illustrated in FIG. 8 includes a process until guiding the target person U to a specified position suitable for image-capturing by the second left-side camera 42b.

Steps S50 to S52 in FIG. 8 are processes the same as or similar to those in steps S1 to S3 in FIG. 5, and the distance degree D of the target person U relative to the specified position PL is recognized. In step S51, the second left-side camera 42b may be activated at the time when the target person U is recognized. In step S53, the lighting control unit 23 determines whether the distance degree D between the target person U and the specified position PL is lower than or equal to a first specified level.

Then, if the distance degree D between the target person U and the specified position PL is lower than or equal to the first specified level, the lighting control unit 23 advances the process to step S60, and if the distance degree D between the target person U and the specified position PL is higher than the first specified level, the lighting control unit 23 advances the process to step S54. In step S60, the lighting control unit 23 turns on the left-side lighting unit 60 and advances the process to step S56.

In step S54, the lighting control unit 23 determines from change in the distance degree D whether the target person U is moving in a direction to be closer to the specified position PL. Then, if the lighting control unit 23 recognizes that the target person U is moving in a direction to be closer to the specified position PL, it advances the process to step S61, and if the lighting control unit 23 recognizes that the target person U is not moving in a direction to be closer to the specified position PL, it advances the process to step S55. In step S55, the lighting control unit 23 makes the left-side lighting unit 60 blinking and advances the process to step S56.

In step S55, the lighting control unit 23 determines from change in the distance degree D whether the target person U is moving in a direction to be away from the specified position PL. Then, if the lighting control unit 23 recognized that the target person U is moving in a direction to be away from the specified position PL, it advances the process to step S62, and if the lighting control unit 23 determines that the target person U is not moving in a direction to be away from the specified position PL, it advances the process to step S56. In step S62, the lighting control unit 23 turns off the left-side lighting unit 60 and advances the process to step S56.

Also, in the case of executing the process according to the flowchart of FIG. 8, by guiding a target person U to an appropriate position in a rapid manner to capture an image of the target person U for authentication, it is possible to save the time required for completing the authentication of the target person U, and this leads an effect of power saving.

Although in the above embodiment, the processor 20 (which corresponds to a computer in the present disclosure) included in the vehicle control device 10 executes the image-capturing assistance method of the present disclosure, a computer or the like included in an external server that communicates with the vehicle 1 may execute the image-capturing assistance method of the present disclosure. In this case, the vehicle 1 transmits information on target objects present around the vehicle 1 to the external server, and the external server transmits control information on the lighting modes of the right-side lighting unit 50 and the left-side lighting unit 60 to the vehicle 1. Alternatively, the target-person recognition unit 21, the distance-degree recognition unit 22, the lighting control unit 23, the target-person-speed recognition unit 24, and the camera control unit 25 may be disposed in the vehicle control device 10 and an external server in a distributed manner.

Note that FIGS. 1 and 2 are schematic diagrams in which the configurations of the vehicle 1 and the image-capturing assistance device 5 are divided according to the main processes to make it easy to understand the invention of the present application, and hence, the configurations of the vehicle 1 and the image-capturing assistance device 5 may be divided differently. The processes of the constituents may be executed by one hardware unit or by a plurality of hardware units. The processes of the constituents in the flowchart illustrated in FIG. 5 may be executed by one program or a plurality of programs.

[5. Configurations Supported by Above Embodiments]

The above embodiments are specific examples of the following configurations.

(First item) An image-capturing assistance device for assisting a camera mounted on a vehicle in capturing an image of surroundings of the vehicle, the image-capturing assistance device including: a lighting unit that is mounted on the vehicle and emits light toward the outside of the vehicle; a target-person recognition unit that recognizes a target person present around the vehicle; a distance-degree recognition unit that recognizes a distance degree of the target person relative to a specified position set within an image-capturing range of the camera; and a lighting control unit that controls a lighting mode of the lighting unit based on the distance degree.

With the image-capturing assistance device according to the first item, it is possible to guide a target person positioned around the vehicle to a position suitable for image-capturing by a camera mounted on the vehicle.

(Second item) The image-capturing assistance device according to the first item, in which the lighting control unit, when recognizing based on change in the distance degree that the target person is coming closer to the specified position, makes the lighting unit blinking, when recognizing based on change in the distance degree that the target person is going away from the specified position, turns off the lighting unit, and when the distance degree is lower than or equal to a first determination level, turns on the lighting unit.

Since the image-capturing assistance device according to the second item switches the lighting mode of the lighting unit between blinking and turning-on based on the distance degree of the target person relative to the specified position, it is possible to guide the target person to the specified position.

(Third item) The image-capturing assistance device according to the first item or the second item, in which the lighting unit has a function of displaying an arrow, and the lighting control unit, when the distance degree is higher than or equal to a second determination level, displays the arrow by using the lighting unit such that the arrow points a direction corresponding to a direction to decrease the distance degree.

Since the image-capturing assistance device according to the third item displays, by using the lighting unit, an arrow pointing a direction to decrease the distance degree of the target person relative to the specified position, it is possible to guide the target person to the specified position.

(Fourth item) The image-capturing assistance device according to the first item, in which the lighting unit includes a lighting element and a sliding unit that slides the lighting element in a width direction of the vehicle, and the lighting control unit slides and positions the lighting element by using the sliding unit such that the lower the distance degree, the longer the distance of the lighting element from an end portion of the sliding unit on a vehicle outer side of the vehicle.

Since the image-capturing assistance device according to the fourth item changes the visibility of the lighting element from the target person according to the distance degree of the target person relative to the specified position, it is possible to guide the target person to the specified position.

(Fifth item) The image-capturing assistance device according to any one of the first item to the fourth item, further including a camera control unit that activates the camera when the distance degree is lower than or equal to a third determination level.

With the image-capturing assistance device according to the fifth item, it is possible to activate the camera and capture an image of the target person when the distance degree of the target person relative to the specified position decreases and the situation becomes suitable for image-capturing by the camera.

(Sixth item) The image-capturing assistance device according to the fifth item, further including a target-person-speed recognition unit that recognizes a moving speed of the target person, in which when the moving speed of the target person recognized by the target-person-speed recognition unit is higher than or equal to a specified speed, the camera control unit does not activate the camera even if the distance degree is lower than or equal to the third determination level.

With the image-capturing assistance device according to the sixth item, in the case in which the moving speed of a target person is higher than or equal to the specified speed, and thus it can be inferred that the target person is likely to pass by near the vehicle, it is possible to save electric power consumption of the camera by prohibiting activation of the camera.

(Seventh item) An image-capturing assistance method executed by a computer, for assisting a camera mounted on a vehicle in capturing an image of surroundings of the vehicle, the image-capturing assistance method including: a target-person recognition step of recognizing a target person present around the vehicle; a distance-degree recognition step of recognizing a distance degree of the target person relative to a specified position set within an image-capturing range of the camera; and a lighting control step of controlling, based on the distance degree, a lighting mode of a lighting unit that is mounted on the vehicle and emits light toward the outside of the vehicle.

By executing the image-capturing assistance method of the seventh item with a computer, it is possible to obtain the operational advantage the same as or similar to that of the image-capturing assistance device of the first item.

### REFERENCE SIGNS LIST

1 vehicle
5 image-capturing assistance device
10 vehicle control device
20 processor
21 target-person recognition unit
22 distance-degree recognition unit
23 lighting control unit
24 target-person-speed recognition unit
25 camera control unit
26 user authentication unit
30 memory
31 control program
41a first right-side camera
41b second right-side camera
42a first left-side camera
42b second left-side camera
50 right-side lighting unit
60 left-side lighting unit
61, 62 LED
63 sliding unit
U target person
PL specified position
D distance degree of U relative to specified position PL

What is claimed is:

1. An image-capturing assistance device for assisting a camera mounted on a vehicle in capturing an image of surroundings of the vehicle, the image-capturing assistance device comprising:
a lighting unit that is mounted on the vehicle and emits light toward outside of the vehicle;
a target-person recognition unit that recognizes a target person present around the vehicle;
a distance-degree recognition unit that recognizes a distance degree of the target person relative to a specified position set within an image-capturing range of the camera; and
a lighting control unit that controls a lighting mode of the lighting unit based on the distance degree.

2. The image-capturing assistance device according to claim 1, wherein
the lighting control unit,
when recognizing based on change in the distance degree that the target person is coming closer to the specified position, makes the lighting unit blinking,
when recognizing based on change in the distance degree that the target person is going away from the specified position, turns off the lighting unit, and
when the distance degree is lower than or equal to a first determination level, turns on the lighting unit.

3. The image-capturing assistance device according to claim 1, wherein
the lighting unit has a function of displaying an arrow, and
the lighting control unit,
when the distance degree is higher than or equal to a second determination level, displays the arrow by using the lighting unit such that the arrow points a direction corresponding to a direction to decrease the distance degree.

4. The image-capturing assistance device according to claim 1, wherein
the lighting unit includes a lighting element and a sliding unit that slides the lighting element in a width direction of the vehicle, and
the lighting control unit slides and positions the lighting element by using the sliding unit such that the lower the distance degree, the longer a distance of the lighting element from an end portion of the sliding unit on a vehicle outer side of the vehicle.

5. The image-capturing assistance device according to claim 1, further comprising
a camera control unit that activates the camera when the distance degree is lower than or equal to a third determination level.

6. The image-capturing assistance device according to claim 5, further comprising
a target-person-speed recognition unit that recognizes a moving speed of the target person, wherein
when the moving speed of the target person recognized by the target-person-speed recognition unit is higher than or equal to a specified speed, the camera control unit does not activate the camera even if the distance degree is lower than or equal to the third determination level.

7. An image-capturing assistance method executed by a computer, for assisting a camera mounted on a vehicle in capturing an image of surroundings of the vehicle, the image-capturing assistance method comprising:
a target-person recognition step of recognizing a target person present around the vehicle;
a distance-degree recognition step of recognizing a distance degree of the target person relative to a specified position set within an image-capturing range of the camera; and
a lighting control step of controlling, based on the distance degree, a lighting mode of a lighting unit that is mounted on the vehicle and emits light toward outside of the vehicle.
